(19) United States
(12) Patent Application Publication
(10) Pub. No.: US 2009/0307980 A1
(43) Pub. Date: Dec. 17, 2009

(54) PLATFORM SCREEN DOOR SYSTEM

(75) Inventor: Mark Hemmings, Wiltshire (GB)

Correspondence Address: BARNES & THORNBURG LLP, 750-17TH STREET NW, SUITE 900, WASHINGTON, DC, 20006-4675, US

(73) Assignee: KNORR-BREMSE RAIL SYSTEMS (UK) LIMITED, Melksham, Wiltshire (GB)

(21) Appl. No.: 12/282,587

(22) PCT Filed: Mar. 15, 2006
(86) PCT No.: PCT/GB2006/000921

§ 371 Date: Feb. 11, 2009

(51) Int. Cl. E05D 15/06; E05F 15/14

(52) U.S. Cl. 49/360

(57) ABSTRACT

A platform screen door system includes a fixed driving panel and at least one door leaf slidable relative to the fixed driving panel. Further included is a telescopic guide including a fixed guide mounted on the fixed driving panel, a moving guide mounted on the at least one door leaf, and a moving intermediate guide mounted on the fixed guide. Also included is a drive means for slidably moving the at least one door leaf from a closed position to an opened position wherein the at least one door leaf overlaps the fixed driving panel.

### CROSS-REFERENCE TO RELATED APPLICATIONS

This application is a National Phase Application based upon and claiming the benefit of priority of PCT/GB2007/000921, filed on Mar. 15, 2007 which is hereby incorporated herein by reference.

### BACKGROUND AND SUMMARY

The present disclosure relates to a platform screen door or gate and a mechanism for opening and closing the door or gate.

The conventional railway station consisting of a raised platform adjacent to the track is essentially the same design as has been used since the beginning of the railway industry in the nineteenth century and is an effective solution to the problem of maximising passenger boarding speed.

However, the basic platform arrangement suffers from several well known problems, such as passengers falling under trains either deliberately or unintentionally and also litter from passengers falling onto the track. Although incidents of people falling under trains are not common, they result in significant disruption to the network and are traumatic incidents for everyone present. The problem of litter on the track has also increased in recent years and can represent a serious health and safety risk on underground or sub-surface systems where the litter will remain in tunnels until it is cleared up.

Platform screen systems or automated platform gates are well known in the railway industry as one approach of dealing with these problems. Due to the problem of lining up doors on the platform and the train, these systems are usually only installed on lines where the rolling stock is standardised, which in practice is on metro or underground systems, although some dedicated high speed systems are also provided with screens.

There are two main types of platform screen door systems in use at present. The most common type is a full height system, for example, vertical screens that are around 2 m high or more. The full height system is usually adopted for newly built railway systems and is in practice essentially in air-conditioned systems, as otherwise the air conditioning system loses air to the rail tunnels, which is highly inefficient.

However, in many systems, particularly older systems, the air in stations is conditioned by the passage of the train through the station, which forces air down the tunnel. In such a system, the use of a full height screen door is precluded as the air throughput to the platform is insufficient to make conditions tolerable. Additionally, many platforms on old systems are quite narrow and a full height screen would be claustrophobic.

One solution to this that has been used is a half height screen or gate. This consists of a rigid vertical screen and gate, usually about 1 m30 to 1 m50 high, which permits the air-conditioning solution provided by the passage of the train to be used and reduces the problems caused by litter and people falling onto the track.

In full height systems, the screen doors are provided with a head structure, which houses an endless belt driven by a pulley at each end over each door. Where the opening comprises two door leaves, one leaf is attached to one part of the belt and the other leaf to the other part of the belt. Driving the belt in one direction will then open the doors.

The use of a head structure is obviously precluded in non full height systems and the known systems use the same approach but mounted into the platform surface. However, it is often difficult to retrofit such a system to a platform as it is expensive to dig channels out of the platform and the channel itself will accumulate dirt. Some solutions box in the mechanism but this approach suffers from the problem that the box stands proud of or extends from the platform forming a step which makes the system harder to use for wheelchair users.

A further problem is that on certain metro systems, the door pitch is quite short, which permits rapid embarkation and disembarkation of passengers. However, when this short pitch is allied with the required clearway when the door or gate is open, it leads to a requirement that the equipment to support and guide the sliding door in the closed position must not interfere with the sliding door or the area adjacent the door when the door is in the open position. The problem is particularly acute in that the loads that the sliding doors must resist must be reacted to over the length of the support and the known head structures are generally not able to provide this due to space constraints.

The present disclosure relates to, among other things, a platform screen gate and door which can operate with a shorter pitch.

According to the present disclosure, a platform screen door system includes a fixed driving panel and at least one door leaf slidable relative to the fixed driving panel. The platform screen door system also includes drive means adapted to slidingly move the door leaf from a door closed position to a door open position in which the leaf lies overlapping with the fixed panel. The platform screen door system further includes a telescopic guide, which guide comprises a fixed guide mounted on the fixed driving panel. The telescopic guide further comprises a moving guide mounted on the door leaf and a moving intermediate guide supported on the fixed guide.

The moving and moving intermediate guides are movable relative to the fixed driving panel or screen on rollers. The moving intermediate guide carries an abutment intermediate their or its length which, when the door is opened, contacts the moving guide to entrain the moving guide and move the moving guide relative to the fixed panel until the door is in the fully opened position. A belt drive is provided to drive the door leaf. A second drive mechanism is provided comprising either a drive wire or motor to drive the door leaf. In an embodiment according to the present disclosure, the second drive mechanism is provided to drive the intermediate moving guide such that the intermediate moving guide is positively driven in a synchronised movement with the moving guide.

Other aspects of the present disclosure will become apparent from the following descriptions when considered in conjunction with the accompanying drawings.

### BRIEF DESCRIPTION OF THE DRAWINGS

FIG. 1 shows a schematic of a platform screen door system, according to the present disclosure.

FIG. 2 shows a schematic of a guidance system for the doors of the system of FIG. 1.

FIG. 3 shows a cross section of the guidance system of FIG. 2.

FIG. 4 shows an embodiment of a drive mechanism including a belt drive, according to the present disclosure.

FIG. 5 shows a schematic of the door system of FIG. 1 in the open position.

FIG. 6 shows a roller arrangement of the door system, according to the present disclosure.

### DETAILED DESCRIPTION

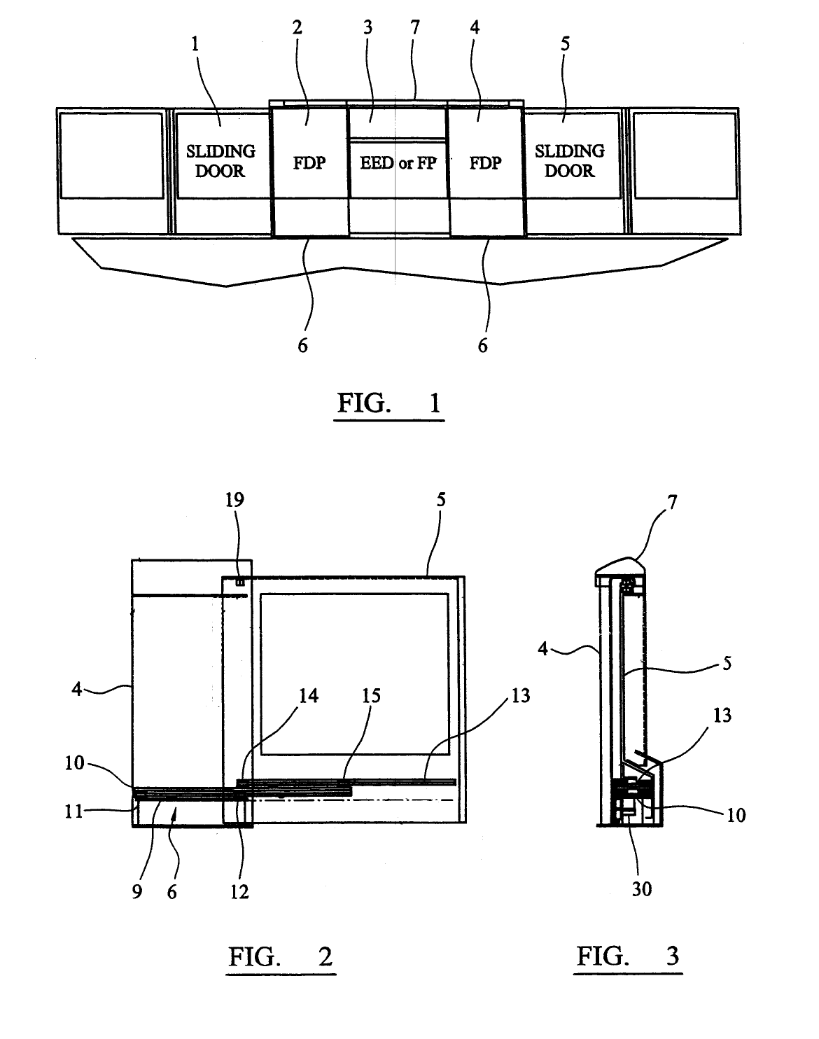

FIG. 1 shows a schematic of a platform screen door system with the sliding doors in the closed position on a railway platform. The system comprises a first sliding door 1 adjacent to a fixed driving panel 2, which fixed driving panel 2 is narrower than the sliding door 1. The fixed driving panel 2 is adjacent to a fixed panel 3 or the pivoting door, which in turn is adjacent to a further fixed driving panel 4, which is adjacent to a further sliding door 5. A guide 6 is provided at the lower edges of the fixed driving panels 2 and 4. A head structure 7 is provided on the upper edge of the fixed driving panels 2 and 4 and the fixed panel 3.

FIG. 2 shows the fixed driving panel 4 and the sliding door 5 in the closed position with the guide 6. The guide 6 comprises a fixed guide 9 comprising two rollers 11, 12 mounted on the frame of the fixed driving panel 4. The guide 6 further comprises a moving door guide 13 and a moving intermediate door guide 10. The intermediate door guide 10 is supported on the rollers 11 and 12 and floats free of the panel 4 and the door 5. Further V-channelled rollers 14,15 are mounted on the intermediate door guide 10. The moving door guide 13 is supported on the rollers 14,15 and is fixed to the door 5. At the upper edge of the fixed driving panel 4 and the sliding door 5, a pair of rollers 19,20 guide the door.

The fixed guide 9 is both adapted to support the moving guide 13 and the intermediate guide 10 and thereby the sliding door 5. To facilitate the support and guidance of the doors over a short distance, the guide 6 is telescopic comprising two sections, the first defined by the rollers 11 and 12, respectively, which sections are fixedly mounted on the fixed position driving panel 4. The second section, which is adapted to slide telescopically within the first section as the door 5 opens is defined by the rollers 14,15. The telescopic nature of the guides 6 and the V-channelled rollers 14, 15 or channels enables the loads applied to the sliding doors 1 to be reacted over a greater length of the support structure than would otherwise be the case with the knock-on effect that bearing loads are considerably reduced.

As the door 1 is opened by a drive mechanism 30, the moving door guide 13 moves relative to both the moving intermediate door guide 10 and the fixed guide 9 until an abutment 70 on the moving intermediate door guide 10 engages the moving door guide 13. Continued movement moves both the moving door guide 13 and the moving intermediate door guide 10 relative to the fixed panel 4 until the door 1 has reached the controlled open position.

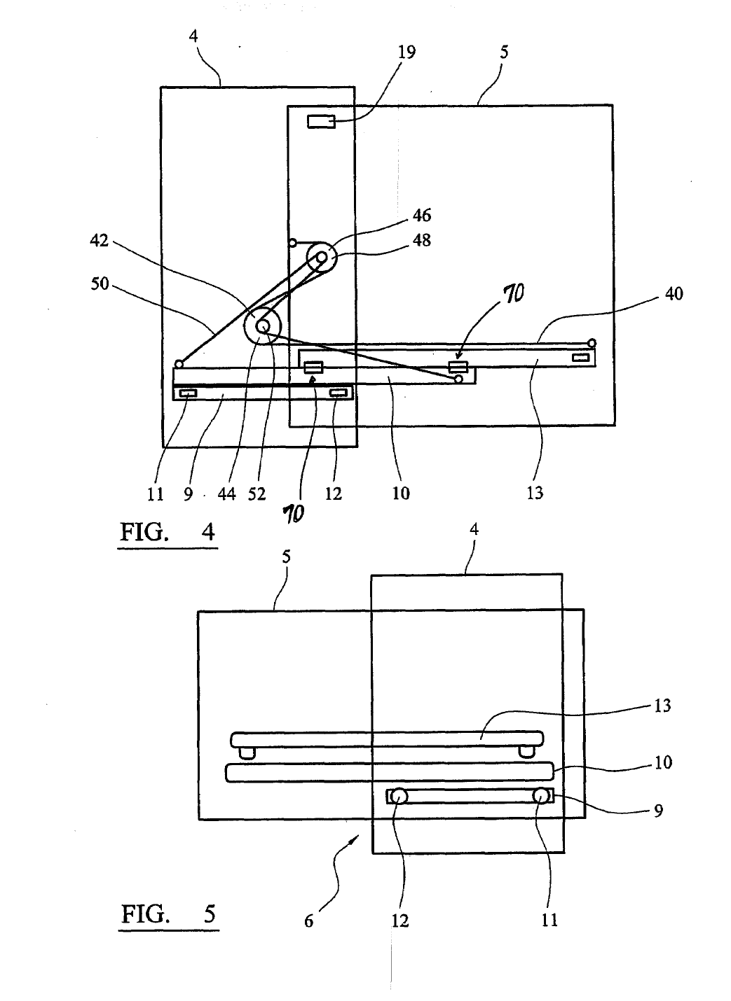

FIG. 3 shows a cross-section view of the fixed driving panel 4 and sliding door 5 and shows the telescopic guide 6 together with the respective rollers, moving door guide 13, moving intermediate door guide 10 and the header arrangement 7. Located adjacent the fixed guide 9 is the drive mechanism 30. The drive mechanism 30 comprises a control unit adapted to actuate an electric motor, which motor drives a belt and pulley arrangement which pulls the door leaf in the appropriate direction to open and close the door 1.

FIG. 4 shows schematically an embodiment according to the present disclosure in which the drive mechanism 30 comprises a belt drive for the guide 6. The belt drive comprises a belt 40 which belt is attached at a first end to the free end of the sliding door or panel 5 slightly above the height at which the moving door guide 13 travels. The second end of the belt 40 is attached to the other end of the door 5 via a driven pulley 44 mounted on the fixed driving panel 4 and a further idler pulley 46 mounted on the door leaf 5. A further driven pulley 42 is rigidly mounted coaxially with the driven pulley 44. A further belt 50 is attached to both ends of the moving intermediate door guide 10 via the third pulley 42 coaxially mounted with the pulley 44 and a fourth, idler pulley 48 mounted co-axially with the pulley 46. A motor 52 is provided to drive the pulleys 42 and 44, thereby driving the guides and the sliding door 5. The third and fourth pulleys 42, 48 are half the size of the pulleys 44, 46.

The use of the belt drive has the advantage that more even power is drawn from the motor 52, in particular at the point when the moving door guide 13 is moved clear of the moving intermediate door guide 10 where current spikes could occur, which the control software might interpret as an obstruction.

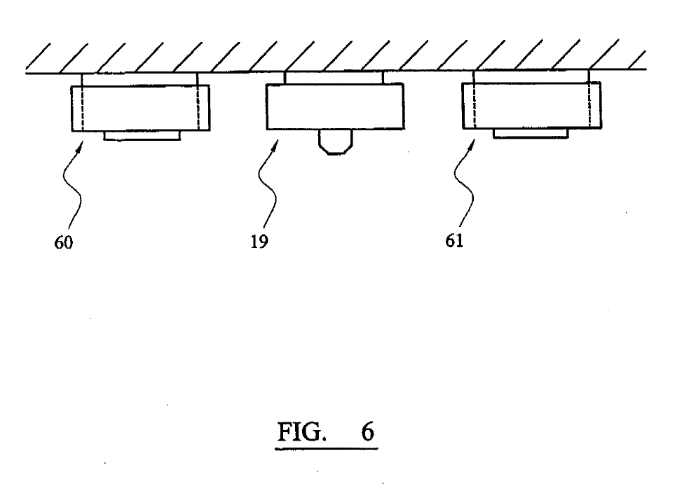

FIG. 5 shows, schematically, the door or door leaf 5 in the open position, showing that the door leaf 5 extends past the fixed driving panel 4. The telescopic guide 6, comprising guide members 9, 10 and 13, are shown in the open position. During the opening of the gate system, the loads caused by the motion of the door 5 are reacted between the rollers 11 and 12, which reduces the loads on the bearings giving the system higher stability.

FIG. 6 shows in greater detail the roller arrangement 19. Adjacent to the roller 19 are two resilient bearing surfaces 60,61 are provided, which bearing surfaces 60,61 are substantially planar with rounded edges. The bearing surfaces 60,61 are provided to support the door leaf 5 under side load conditions as it moves, thereby removing some of the forces acting on a respective roller, for example, roller 19, to extend its life. Under some conditions a double roller arrangement may be used.

The telescopic mechanism, according to the present disclosure, is suitable for use in both full height platform screen doors and also half height automatic gates. The term screen door applies also to half height systems and gates. The system, according to the present disclosure, allows for the installation and operation of a platform sliding door in situations where a short door pith is provided on the trains which pitch makes it extremely difficult using the existing technology to provide platform doors aligned with all the doors on a train.

In place of the roller arrangement, it is within the scope of the present disclosure to use a linear slide arrangement, using, for example, low friction plastics or ball bearings.

It is also within the scope of the present disclosure to use a damping arrangement to damp the acceleration and deceleration of the moving intermediate door guide 10 and thereby avoid using a second belt drive. Alternatively, it is within the scope of the present disclosure wherein a linear motor could be used as the drive means.

Although the present disclosure has been described and illustrated in detail, it is to be clearly understood that this is done by way of illustration and example only and is not to be taken by way of limitation. The scope of the present disclosure is to be limited only by the terms of the appended claims.

I claim:

1. A platform screen door system comprising:
a fixed driving panel;
at least one door leaf slidable relative to the fixed driving panel;
a telescopic guide including a fixed guide mounted on the fixed driving panel, a moving guide mounted on the at least one door leaf, and a moving intermediate guide mounted on the fixed guide; and
drive means for slidably moving the at least one door leaf from a closed position to an opened position wherein the at least one door leaf overlaps the fixed driving panel.

2. The platform screen door system according to claim 1, wherein the moving guide and the moving intermediate guide are movable on rollers relative to the fixed driving panel.

3. The platform screen door system according to claim 1, wherein the moving intermediate guide includes an abutment intermediate a length of the moving intermediate guide, which, when the at least one door leaf is opened, the abutment contacts the moving guide to entrain the moving guide and move the moving guide relative to the fixed driving panel until the at least one door leaf is in the opened position.

4. The platform screen door system according to claim 1, further comprising a belt drive configured to drive the at least one door leaf between the closed and opened positions.

5. The platform screen door system according to claim 1, further comprising a second drive means configured as one of a drive wire and a motor to drive the at least one door leaf between the closed and opened positions.

6. The platform screen door system according to claim 5, wherein the second drive means drives the moving intermediate guide such that the moving intermediate guide is driven in a synchronised movement with the moving guide.
